(19) United States
(12) Patent Application Publication
(10) Pub. No.: US 2026/0342675 A1
(43) Pub. Date: Oct. 29, 2026

(54) MODEL MONITORING FOR ML-BASED CSI COMPRESSION

(71) Applicant: Google LLC, Mountain View, CA (US)

(72) Inventors: Yushu Zhang, Beijing (CN); Chih-Hsiang Wu, Taipei City (TW)

(21) Appl. No.: 19/110,025

(22) PCT Filed: Sep. 30, 2022
(86) PCT No.: PCT/CN2022/123623

§ 371 Date: Mar. 7, 2025

(51) Int. Cl. H04L 41/16; H04B 7/06; H04W 72/21

(52) U.S. Cl. CPC H04L 41/16; H04B 7/0626; H04W 72/21

(57) ABSTRACT

A UE (102) receives (310a-310b), from a network entity (104), at least one downlink signal for monitoring (316a-316b) a performance of an ML model used for CSI compression. The monitoring (316a-316b) the performance is based on a measurement value of the at least one downlink signal. The UE transmits (318, 414a-414b) to the network entity (104) based on the measurement value of the at least one downlink signal, information associated with the performance of the ML model used for the CSI compression. The UE communicates (322) with the network entity (104) when the information associated with the performance of the ML model indicates a performance failure, where the communication (322) applies at least one of: an update to the ML model, a switch of the ML model to a different ML model, or non-ML CSI reporting.

### TECHNICAL FIELD

The present disclosure relates generally to wireless communication, and more particularly, to performance failure monitoring of machine learning (ML) models.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband have been useful to continue the progression of such wireless communication technologies. For example, machine learning (ML) models might improve wireless performance but ML models might also experience performance failures for certain types of channel conditions or as a result of blockages to the channel.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A user equipment (UE) may utilize a machine learning (ML) model to perform channel state information (CSI) compression for transmitting a compressed CSI report to a network entity, such as a base station or an entity of a base station. However, some ML models might experience a performance failure for certain types of channel conditions. For example, the ML model might be trained using offline field data associated with some channel conditions, but the offline field data might be more difficult to obtain for another, less common channel condition, which may lead to the performance failure of the ML model during an inference phase. In addition, the channel might experience a change as a result of blockages to the channel, which might also cause the ML model to experience the performance failure.

Aspects of the present disclosure address the above-noted and other deficiencies by configuring the UE to monitor the performance of the ML model and to indicate to the network entity when the performance failure of the ML model occurs, so that the UE and/or the network entity can adjust the ML model. For example, the UE and the network entity may update/switch the ML model or fallback to non-ML communication techniques. Either the UE or the network entity may be capable of detecting an ML model failure. Whichever entity detects the ML model failure may then indicate the ML model failure to the other entity. Based on ML model failure detection and reporting, the UE and the network entity can adjust communications managed by the ML model.

According to some aspects, the UE receives, from the network entity, at least one downlink signal for monitoring a performance of an ML model used for the CSI compression. While monitoring the performance, the UE measures the at least one downlink signal. The UE transmits, to the network entity based on a measurement value of the at least one downlink signal, information associated with the performance of the ML model used for the CSI compression. The UE communicates with the network entity when the information associated with the performance of the ML model indicates a performance failure. The communication applies at least one of: updating the ML model, switching the ML model, or using non-ML CSI reporting.

According to some aspects, a network entity transmits, to the UE, the at least one downlink signal for the monitoring the performance of the ML model used for the CSI compression. The network entity receives, from the UE based on a measurement value of the at least one downlink signal, the information associated with the performance of the ML model used for the CSI compression. The network entity modifies communication with the UE when the information associated with the performance of the ML model indicates the performance failure. The communication modification applies at least one of: the updating to the ML model, the switching of the ML model to a different ML model, or the using of non-ML CSI reporting.

To the accomplishment of the foregoing and related ends, the one or more aspects correspond to the features hereinafter described and particularly pointed out in the claims. The one or more aspects may be implemented through any of an apparatus, a method, a means for performing the method, and/or a non-transitory computer-readable medium. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 illustrates a diagram of a wireless communications system including a plurality of user equipments (UEs) and network entities in communication over one or more cells.

FIG. 2 illustrates a diagram of an example procedure for machine learning (ML)-based channel state information (CSI) encoder compression at a UE and ML-based CSI decoder decompression at a network entity.

FIG. 3 is a signaling diagram that illustrates an example of UE-based ML model monitoring.

FIG. 4 is a signaling diagram that illustrates an example of network-based ML model monitoring.

FIG. 5 is a flowchart of a method performed by a UE for performance failure monitoring of an ML.

FIG. 6 is a flowchart of a method performed by a network entity for performance failure monitoring of an ML.

FIG. 7 is a diagram illustrating an example of a hardware implementation for an example UE apparatus.

FIG. 8 is a diagram illustrating an example of a hardware implementation for one or more example network entities.

### DETAILED DESCRIPTION

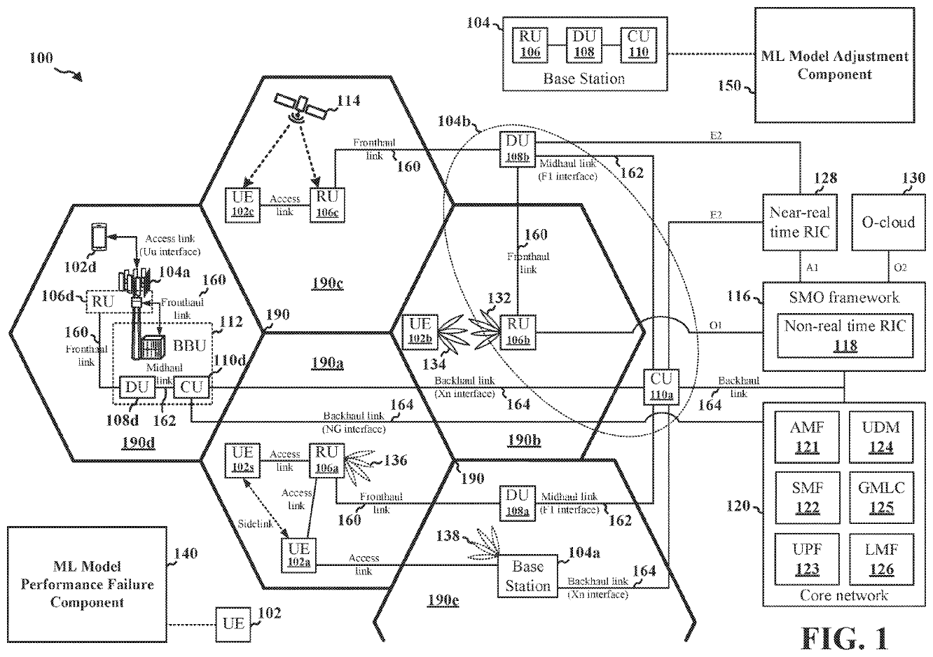

FIG. 1 illustrates a diagram 100 of a wireless communications system associated with a plurality of cells 190. The wireless communications system includes user equipments (UEs) 102 and base stations 104, where some base stations 104a include an aggregated base station architecture and other base stations 104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUs 106b-106c via respective fronthaul links 160. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104a of the cell 190e simultaneously serve.

One or more CUs 110, such as the CU 110a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link 164 based on an Xn interface. For example, the CU 110d of the base station 104a communicates with the CU 110a of the base station 104b over the backhaul link 164 based on the Xn interface. Similarly, the base station 104a of the cell 190e may communicate with the CU 110a of the base station 104b over a backhaul link 164 based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104a of the cell 190e via cross-cell communication beams of the RU 106a and the base station 104a.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134 of the UE 102b, which may correspond to inter-cell communication beams or cross-cell communication beams. Both real-time and non-real-time features of control plane and user plane communications of the RUs 106 can be controlled by associated DUs 108. Accordingly, the DUs 108 and the CUS 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 115 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Hence, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104a of cell 190d to transmit a downlink/forward link communication to the UE 102d or receive an uplink/reverse link communication from the UE 102d based on the Uu interface associated with the access link between the UE 102d and the base station 104a/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHz-52.6 GHz. Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHZ-24.25 GHz. Frequency bands within FR3 may include characteristics of FR1 and/or FR2. Hence, features of FR1 and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHz-71 GHz, FR4, which ranges from 71 GHz-114.25 GHZ, and FR5, which ranges from 114.25 GHZ-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134 from the RU 106b in one or more receive directions of the UE 102b. In a further example, the UE 102b may also transmit an uplink beamformed signal to the RU 106b based on the second set of beams 134 in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104a and a second base station 104b. For instance, the RU 106a of cell 190a may transmit a beamformed signal based on an RU beam set 136 to the base station 104a of cell 190e in one or more transmit directions of the RU 106a. The base station 104a of the cell 190e may receive the beamformed signal from the RU 106a based on a base station beam set 138 in one or more receive directions of the base station 104a. Similarly, the base station 104a of the cell 190e may transmit a beamformed signal to the RU 106a based on the base station beam set 138 in one or more transmit directions of the base station 104a. The RU 106a may receive the beamformed signal from the base station 104a of the cell 190e based on the RU beam set 136 in one or more receive directions of the RU 106a.

The base station 104 may include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a transmit reception point (TRP), a network node, a network entity, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include a machine learning (ML) performance failure component 140 configured to receive, from a network entity, at least one downlink signal for monitoring a performance of a ML model used for channel state information (CSI) compression, wherein the monitoring the performance is based on a measurement value of the at least one downlink signal; transmit, to the network entity based on the measurement value of the at least one downlink signal, information associated with the performance of the ML model used for the CSI compression; and communicate with the network entity when the information associated with the performance of the ML model indicates a performance failure, wherein the communication applies at least one of: an update to the ML model, a switch of the ML model to a different ML model, or non-ML CSI reporting.

In certain aspects, the base station 104 or a network entity of the base station 104 may include an ML model adjustment component 150 configured to transmit, to a UE, at least one downlink signal for monitoring a performance of a ML model used for CSI compression; receive, from the UE based on a measurement value of the at least one downlink signal, information associated with the performance of the ML model used for the CSI compression; and modify communication with the UE when the information associated with the performance of the ML model indicates a performance failure, wherein the communication modification applies at least one of: an update to the ML model, a switch of the ML model to a different ML model, or non-ML CSI reporting.

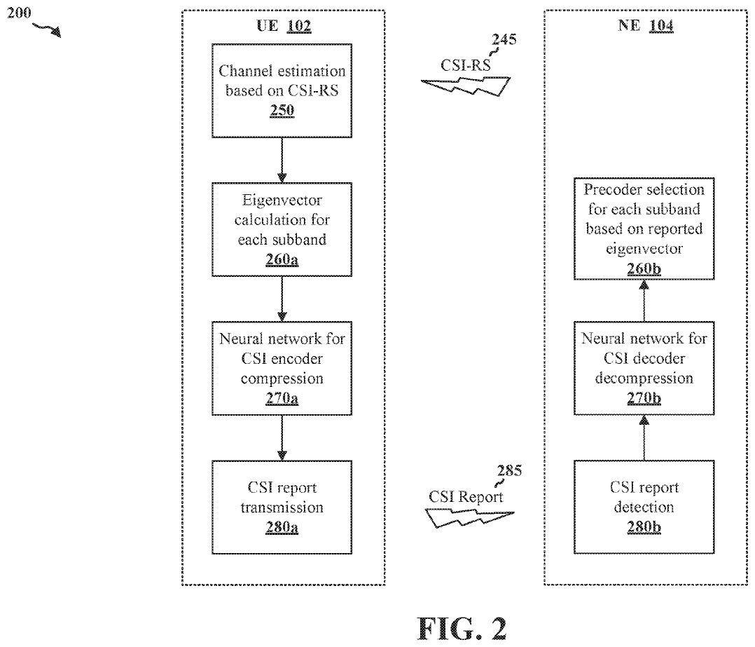

Accordingly, FIG. 1 describes a wireless communication system that may be implemented in connection with aspects of one or more other figures described herein, such as aspects illustrated in FIGS. 2-4. Further, although the following description may be focused on 5G NR, the concepts described herein may be applicable to other similar areas, such as 5G-Advanced and future versions, LTE, LTE-advanced (LTE-A), and other wireless technologies.

FIG. 2 illustrates a diagram 200 of an example procedure for ML-based CSI encoder compression at a UE 102 and ML-based CSI decoder decompression at a network entity 104. The UE 102 and the network entity 104, such as a base station or an entity of a base station, might perform multiple-input multiple-output (MIMO) communications, where the network entity 104 can use CSI to select a digital precoder for the UE 102. The network entity 104 might configure CSI reporting from the UE 102 via RRC signaling (e.g., CSI-reportConfig), where the UE 102 may use a channel state information-reference signal (CSI-RS) 245 as a channel measurement resource (CMR) for the UE 102 to measure a downlink channel. The network entity 104 may also configure (e.g., via the CSI-reportConfig) an interference measurement resource (IMR) for the UE 102 to measure interference to the downlink channel. Accordingly, the UE 102 may estimate 250 a channel between the UE 102 and the network entity 104 based on the CSI-RS 245.

The UE 102 may determine the CSI using the CMR and/or the IMR configured by the network entity 104, and include the CSI in a CSI report 285 transmitted 280a to the network entity 104, after calculation 260a of an eigenvector for each subband and compression 270a of a CSI encoder. The CSI may include a rank indicator (RI), a precoder matrix indicator (PMI), a channel quality indicator (CQI) and/or a layer indicator (LI). The network entity 104 can use the RI and the PMI to determine the digital precoder. The CQI might be indicative of a signal-to-interference plus noise ratio (SINR) for determining a modulation and coding scheme (MCS). The LI might indicate a strongest layer, such as used for multi-user (MU)-MIMO paring of a low rank transmission with precoder selection 260b, such for phase-tracking reference signals (PT-RSs).

The network entity 104 may configure (e.g., based on the CSI-reportConfig) a time domain behavior, such as periodic, semi-persistent, or aperiodic reporting, for the transmission 280a of the CSI report 285 to the network entity 104. In examples, the network entity 104 may activate/deactivate a semi-persistent CSI report from the UE 102 using a MAC-control element (MAC-CE). The network entity 104 may trigger an aperiodic CSI report from the UE 102 based on transmission of downlink control information (DCI) to the UE 102. The network entity 104 may receive a periodic CSI report from the UE 102 on physical uplink control channel (PUCCH) resources (e.g., configured via the CSI-reportConfig). The CSI-reportConfig may also be used to configure PUCCH resources for transmission 280a of the semi-persistent CSI report to the network entity 104. In other examples, transmission 280a of the semi-persistent CSI report to the network entity 104 may be on physical uplink shared channel (PUSCH) resources triggered by the DCI. The UE 102 may likewise transmit 280a the aperiodic CSI report on the PUSCH resources triggered by the DCI.

For a first resource element (RE) k associated with the CSI-RS 245, the received signal at the UE 102 may be determined based on:

Yₖ=HₖXₖ+Nₖ

where Hₖ indicates an effective channel including an analog beamforming weight with dimensions N_{Rx} by N_{Tx}, Xₖ corresponds to the CSI-RS 245 at RE k, Nₖ corresponds to the interference plus noise, N_{Rx} corresponds to a first number of receiving ports, and N_{Tx} corresponds to a second number of transmission ports.

For a second RE k associated with a physical downlink shared channel (PDSCH), the signal received at the UE 102 may be determined based on:

Yₖ=HₖWₖXₖ+Nₖ

where Wₖ indicates the precoder. The network entity 104 might select 260b a same precoder for subcarriers within a subband (e.g., bundled in a physical resource block (PRB)).

The UE 102 can use a Type 2 CSI codebook for CSI measurement and reporting, where the precoder might be based on:

W=W₁W₂

where W₁ corresponds to a wideband precoder with dimension N_{Tx} by 2L, W₂ corresponds to a subband precoder with dimensions 2L by v, L indicates a number of beams, and v indicates a number of layers, which may correspond to RI+1. W₁ might be based on the codebook, while W₂ might be based on a power and angle associated with each transmission. Since W₂ is based on the subband and there may be multiple subbands for the CSI report 285, the UE 102 might experience a large overhead to transmit 280a the CSI report 285 to the network entity 104.

The CSI report 285 may be based on the bandwidth for the CSI-RS 245. In examples, the codebook that the network entity might use for selection 260b of W₁ may be based on:

$${W}_{1} = [ \begin{matrix}B & 0 \\ 0 & B\end{matrix} ]$$

$$B = [ \begin{matrix}{b}_{1} & {b}_{2} & … & {b}_{L}\end{matrix} ]$$

$${b}_{l} = {u}_{m} ⊗ {v}_{n}$$

$${u}_{m} = {[ \begin{matrix}1 & {e}^{\frac{j 2 π m}{{N}_{1} {O}_{1}}} & … & {e}^{\frac{j 2 π ( {N}_{1} - 1 ) m}{{N}_{1} {O}_{1}}}\end{matrix} ]}^{T}$$

$${v}_{n} = {[ \begin{matrix}1 & {e}^{\frac{j 2 π n}{{N}_{2} {O}_{2}}} & … & {e}^{\frac{j 2 π ( {N}_{2} - 1 ) n}{{N}_{2} {O}_{2}}}\end{matrix} ]}^{T}$$

where ⊗ corresponds to a Kronecker product, L indicates the number of beams, which may be configured via RRC signaling, N₁ and N₂ correspond to the number of ports, O₁ and O₂ correspond to an oversampling factor in a horizontal and vertical domain, which may be configured via the RRC signaling. Candidate values for the oversampling factor may be based on the number of CSI-RS ports indicated via N₁ and N₂. The codebook might include precoders with different values m and n. In some examples, the candidate values may be predefined based on standardized protocols.

ML models may be implemented to compress 270a the CSI encoder associated with the channel estimation 250. A first v columns of an eigenvector calculated 260a for each subband of an average channel may be used as input to the ML model. In examples, the eigenvector may be input to a neural network at the UE 102 for compression 270a of the CSI encoder. The UE 102 transmits 280a, to the network entity 104, the CSI report 285 including the compressed CSI encoder.

The network entity 104 detects 280b the CSI report 285 transmitted 280a from the UE 102 and decodes the CSI report 285 including the compressed CSI encoder. The decoded CSI report 285 including the compressed CSI encoder may be input to a neural network at the network entity 104 for decompression 270a. That is, the neural network at the network entity 104 may decompress 270b the compressed CSI encoder to determine a decompressed CSI decoder. The network entity 104 may determine, from the decompressed CSI decoder, the eigenvector used as input for the compression 270a of the CSI encoder at the UE 102. The network entity 104 may select 260b a precoder for each subband based on the determined/reported eigenvector.

Some ML models might experience a performance failure for certain types of channel conditions. For example, the ML model might be trained using offline field data associated with certain channel conditions, but the offline field data might be more difficult to obtain for other, less common channel conditions, which may lead to the performance failure of the ML model during an inference phase. In addition, the channel might experience a change in the condition of the channel as a result of blockages to the channel, which might also cause the ML model to experience the performance failure.

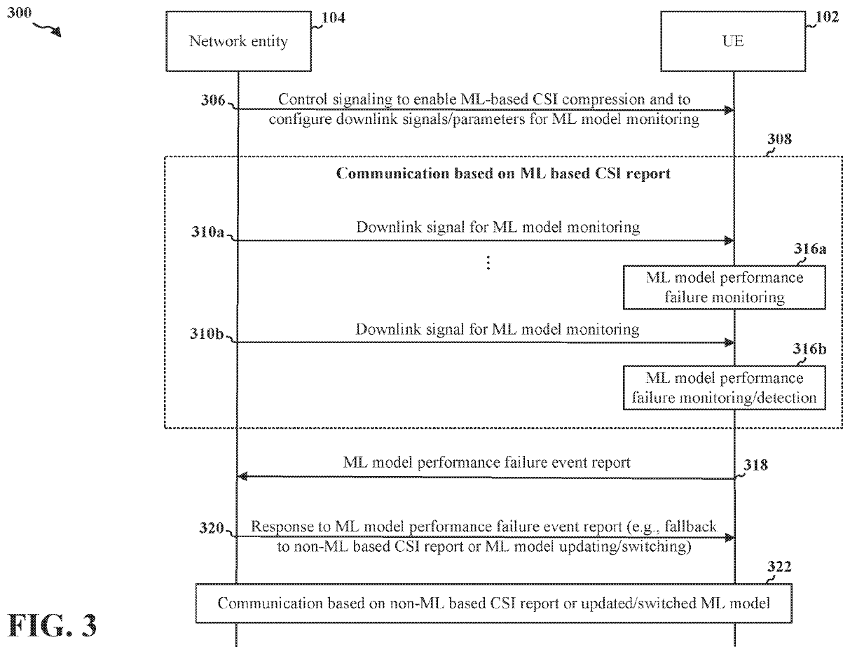

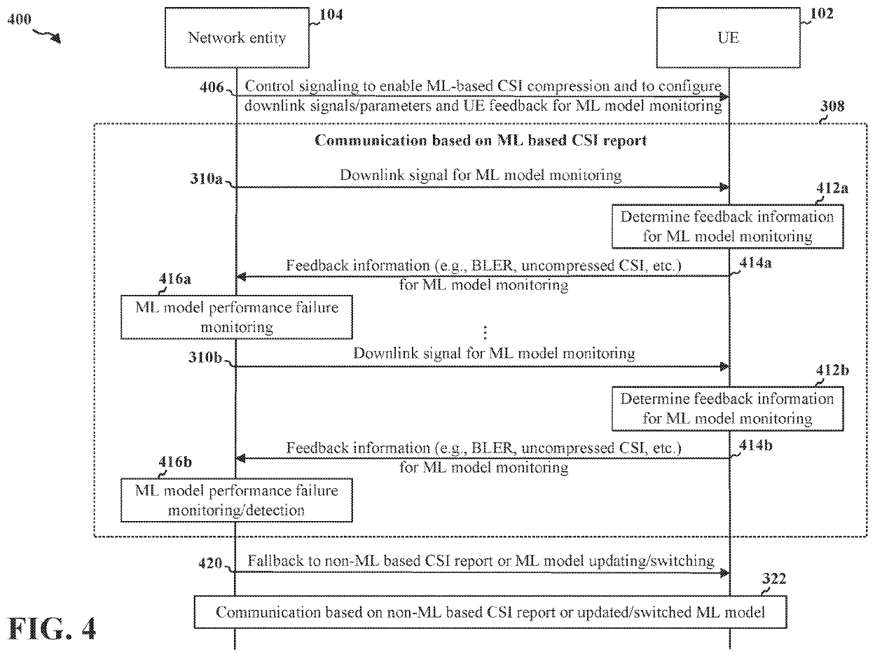

Accordingly, the network entity 104 might configure the UE 102 to monitor the performance of the ML model and indicate to the network entity 104 when the performance failure of the ML model occurs, so that the UE 102 and/or the network entity 104 can adjust the ML model. For example, the UE 102 and the network entity 104 may update/switch the ML model or fallback to non-ML based communication techniques. Both the UE 102 and the network entity 104 may be capable of detecting an ML model failure. Whichever entity detects the ML model failure may then indicate the ML model failure to the other entity. Based on ML model failure detection and reporting, the UE 102 and the network entity 104 can adjust communications associated with the ML model. That is, the UE 102 and/or the network entity 104 may perform ML model performance failure detection, failure event reporting, and ML model updating/switching. FIG. 2 describes CSI compression/decompression using an ML model. FIGS. 3-4 describe monitoring the performance of the ML model.

FIG. 3 is a signaling diagram 300 that illustrates an example of UE-based ML model monitoring. The network entity 104 can transmit 306 control signaling to the UE 102 to enable ML-based CSI compression, and to configure downlink signals/parameters for the ML model monitoring. The downlink signals for the ML model monitoring may correspond to CSI-RS, PDSCH transmissions, etc. The parameters for the ML model monitoring may correspond to an ML model performance failure detection counter, an ML model performance failure detection threshold, an uplink resource for transmitting an ML model performance failure report, etc.

The network entity 104 can transmit 306 the control signaling to the UE 102 via RRC signaling, MAC-CE, or DCI and proceed to communicate 308 with the UE 102 based on an ML-based CSI report described with respect to FIG. 2. In examples, the RRC signaling may include an RRCReconfiguration message. In some cases, the UE 102 is in dual connectivity with the network entity 104 (e.g., operating as a secondary node (SN)) and another network entity (e.g., operating as a master node (MN) not shown in FIG. 3) similar to the network entity 104. In examples, the SN transmits the control signaling to the UE 102, as described above. In other examples, the SN transmits the control signaling to the UE 102 via the MN. The communication 308 with the UE 102 based on the ML-based CSI report may be independent of, or simultaneous with, with transmission 310a-310b of one or more downlink signals to the UE 102 for ML model monitoring. For example, the communication 308 based on the ML-based CSI report and the transmission 310a-310b of the one or more downlink signals may be associated with punctured resources. The UE 102 measures the one or more downlink signals transmitted 310a-310b from the network entity 104 for ML model performance failure monitoring 316a-316b and/or detection 316b. For example, if the UE 102 identifies N consecutive ML model performance failure instances based on the ML model performance failure monitoring 316a-316b, the UE 102 might determine that an ML model performance failure event is detected 316b and transmit 318 an ML model performance failure event report to the network entity 104.

The downlink signal transmitted 310a-310b for the ML model monitoring may be a precoded CSI-RS, which may be transmitted on a periodic basis. In other examples, the CSI-RS may be transmitted to the UE 102 on a semi-persistent basis. The network entity 104 may transmit the CSI-RS from NR antenna ports, where NR corresponds to a maximum number of downlink layers configured by the RRC signaling. The network entity 104 might transmit the CSI-RS with a precoder for a most recent ML-based CSI report.

The UE 102 may calculate a cosine similarity or a square cosine similarity based on a normalized eigenvector and an estimated channel that the UE 102 determined from the CSI-RS for the ML-based CSI report and the normalized estimated channel. The calculations may correspond to:

$$CS = \frac{1}{{N}_{s}} {\sum }_{i = 1}^{{N}_{S}} {\sum }_{j = 1}^{{N}_{R}} \frac{‖ {\tilde{W}}_{i , j}^{H} {W}_{i , j} ‖}{‖ {\tilde{W}}_{i , j} ‖ ‖ {W}_{i , j} ‖}$$

$$SCS = \frac{1}{{N}_{s}} {\sum }_{i = 1}^{{N}_{S}} {\sum }_{j = 1}^{{N}_{R}} {( \frac{‖ {\tilde{W}}_{i , j}^{H} {W}_{i , j} ‖}{‖ {\tilde{W}}_{i , j} ‖ ‖ {W}_{i , j} ‖} )}^{2}$$

$${\tilde{W}}_{i , j} = {\tilde{H}}_{i} , {\tilde{V}}_{i , j}$$

where W_{i,j} indicates a j^{th} column of an estimated channel at an i^{th} subband from the CSI-RS for the model performance failure monitoring, N_{S} corresponds to a number of subbands, \tilde{H}ᵢ corresponds to the estimated channel at the i^{th} subband from the CSI-RS for ML-based CSI feedback, and \tilde{V}_{i,j} corresponds to the j^{th} column of the eigenvector of the estimated channel for the CSI-RS for the ML-based CSI feedback at the i^{th} subband. If the cosine similarity or the square cosine similarity is below a threshold, the UE 102 might determine that an ML model performance failure instance has occurred. The threshold may be predefined or configured via RRC signaling from the network entity 104.

The UE 102 may calculate a block error ratio (BLER) (e.g., hypothetical BLER) based on the CSI-RS for the ML model monitoring and at least one of the CQI and the RI for the most recent ML-based CSI report, a target spectrum efficiency per layer, or a target spectrum efficiency per number of layers. The target spectrum efficiency may be predefined or configured by the network entity 104 based on RRC signaling. The UE 102 can determine the hypothetical BLER based on a first Ñ_{R} ports for the CSI-RS for the ML model monitoring, where Ñ_{R} corresponds to the number of layers indicated by the RI in the most recent ML-based CSI report. If the hypothetical BLER is above the threshold (or otherwise fulfills a first threshold criterion), the UE 102 might determine that an ML model performance failure instance has occurred. The threshold for the BLER used for CQI selection, or for the CQI selection plus an offset, may be predefined or configured via RRC signaling from the network entity 104.

The one or more downlink signals transmitted 310a-310b for the ML model monitoring may correspond to non-precoded CSI-RS. The non-precoded CSI-RS may be the same CSI-RS as used for the ML-based CSI report. In other examples, the CSI-RS may be a dedicated CSI-RS for the ML model monitoring, which may be based on a same number of ports as the CSI-RS used for the ML-based CSI report. The network entity 104 might transmit, to the UE 102, indications of the ML model for decompression. The UE 102 may calculate the cosine similarity or the square cosine similarity based on a first eigenvector for the channel estimated from the CSI-RS and a second eigenvector for ML-based CSI compression and decompression associated with the ML model used for compressing and decompressing the CSI. If the cosine similarity or the square cosine similarity is below the threshold (or otherwise fulfills a second threshold criterion), the UE 102 might determine that an ML model performance failure instance has occurred. The threshold may be predefined or configured via RRC signaling from the network entity 104.

The one or more downlink signals transmitted 310a-310b for the ML model performance failure monitoring may correspond to a PDSCH transmission, which may include demodulation reference signal (DMRS) in the PDSCH transmission. For different MIMO transmission schemes, such as MU-MIMO or single-user (SU)-MIMO, the PDSCH with the precoder reported in the most recent ML-based CSI report is used for the ML model monitoring. Thus, the network entity 104 may indicate in the DCI that schedules the PDSCH whether the PDSCH (e.g., DMRS in the PDSCH) is used for the ML model monitoring. A 1-bit field may be included in the DCI (e.g., DCI format 1_1 or DCI format 1_2) to provide an indication of whether the PDSCH is used for the ML model monitoring. The UE 102 may calculate the cosine similarity or the square cosine similarity of the estimated channel for the DMRS of the PDSCH and the eigenvector and the estimated channel for the CSI-RS for the ML-based CSI report. If the cosine similarity or the square cosine similarity is below the threshold (or otherwise fulfills a second threshold criterion), the UE 102 might determine that an ML model performance failure instance has occurred. The threshold may be predefined or configured via RRC signaling from the network entity 104.

The UE 102 may calculate the hypothetical BLER based on the DMRS in the PDSCH and the CQI and RI in the most recent ML-based CSI report. In other examples, the UE 102 may calculate the hypothetical BLER based on the DMRS in the PDSCH and a scheduled MCS. If the hypothetical BLER is above a threshold (or otherwise fulfills a third threshold criterion), the UE 102 might determine that an ML model performance failure instance has occurred. The threshold for the BLER used for CQI selection, or for the CQI selection plus an offset, may be predefined or configured via RRC signaling from the network entity 104. The most recent ML-based CSI report might correspond to a most recent ML-based CSI report using the implemented ML model Y slots before a slot that includes the one or more downlink signals 310a-310b transmitted for the ML model monitoring, where Y may be predefined (e.g., Y=0), or configured via RRC signaling from the network entity 104.

The UE 102 might detect 316b the ML model performance failure after determining that N consecutive ML model performance failure instances have occurred. In an example, N may correspond to one of 1, . . . , 32. In another example, N may be based on a predefined protocol. In yet another example, N may be configured via RRC signaling from the network entity 104. The UE 102 can increment the ML model performance failure detection counter to count a number of consecutive ML model performance failure instances. For example, the UE 102 may initialize the ML model performance failure detection counter to an initial value (e.g., zero) when the UE 102 receives 306 the control signaling from the network entity 104. The UE 102 increments the ML model performance failure detection counter by one after each ML model performance failure instance. If the ML model performance failure detection counter reaches N, the UE 102 declares an ML model performance failure event. The network entity 104 may configure a time interval for ML model performance failure monitoring 316a-316b based on RRC signaling. In another example, the time interval for the ML model performance failure monitoring 316a-316b may be determined by the UE 102 based on a time interval for the one or more downlink signals.

After detection 316b of an ML model performance failure event, the UE 102 transmits 318 an ML model performance failure event report to the network entity 104, and the network entity 104 transmits 320 a response to the ML model performance failure event report to the UE 102. The response transmitted 320 to the UE 102 might indicate that communications between the network entity 104 and the UE 102 are to fallback to non-ML based CSI reporting techniques, or that the ML model is to be updated or switched. Accordingly, the UE 102 and the network entity 104 may proceed to communicate 322 based on the non-ML based CSI reporting techniques or the updated/switched ML model, as indicated in the response transmitted 320 to the UE 102.

If the UE 102 determines, after receiving 310a-310b a downlink signal from the network entity 104, that there is not an ML model performance failure, the UE 102 can reset the ML model performance failure detection counter to zero. In another example, if the UE 102 determines that there is not an ML model performance failure and the ML model performance failure detection counter is larger than one, the UE 102 can de-increment the ML model performance failure detection counter. In still another example, if the UE 102 determines that there is not an ML model performance failure for M consecutive instances (e.g., occasions, slots, etc.), the UE 102 can reset the ML model performance failure detection counter to zero. In yet another example, if the UE 102 determines that there is not an ML model performance failure for M consecutive instances (e.g., occasions or slots) and the ML model performance failure detection counter is larger than one, the UE 102 can de-increment the ML model performance failure detection counter. A value of M may correspond to one of 1, . . . , 32, based on a predefined protocol, or configured by the network entity 104 through in the control signaling. The network entity 104 may configure M to be less than or equal to N, in some cases, or larger than to N in other cases. FIG. 3 illustrates model performance failure monitoring from a UE-side of a communication environment. FIG. 4 illustrates model performance failure monitoring from a network entity-side of the communication environment.

FIG. 4 is a signaling diagram 400 that illustrates an example of network-based ML model monitoring. Elements 308, 310a-310b, and 322 in the signaling diagram 400 have already been described with respect to FIG. 3. Similar to the control signaling transmitted 306 from the network entity 104 to the UE 102 in the signaling diagram 300, the control signaling transmitted 406 from the network entity 104 to the UE 102 also enables ML-based CSI compression and configures downlink signals/parameters. However, the control signaling transmitted 406 in the signaling diagram 400 also configures UE feedback for ML model monitoring.

The network entity 104 may configure the UE 102 to report uncompressed CSI based on at least one of the CSI-RS resources configured for ML-based CSI compression. The network entity 104 may use RRC signaling to configure at least one reporting parameter. The configured parameters may correspond to a subband size for the uncompressed CSI, a first number of bits for amplitude quantization for each coefficient, a second number of bits for phase quantization for each coefficient, a third number of reported strongest coefficients, etc. In other examples, the parameters may be based on a predefined protocol, such as the reported CSI corresponding to a wideband CSI where a number of the subband size is 1, the number of bits for phase and amplitude quantization being equal to 3, the number of reported strongest coefficients being a maximum number of downlink layers multiplied by a number of antenna ports for the CSI-RS, etc.

The UE 102 might determine 412a-412b feedback information for ML model monitoring based on receiving 310a-310b one or more downlink signals from the network entity 104 for ML model monitoring. The UE 102 transmits 414a-414b the feedback information (e.g., BLER, uncompressed CSI, etc.) to the network entity 104 for ML model monitoring after determining 412a-412b the feedback information for the ML model monitoring. For example, the UE 102 may report uncompressed CSI on PUCCH/PUSCH resources. The network entity 104 may configure or indicate, to the UE 102, the PUCCH/PUSCH resources for reporting the uncompressed CSI report. The uncompressed CSI reported transmitted 414a-414b to the network entity 104 as feedback information may correspond to the eigenvector for the estimated channel of the CSI-RS, where v_{i,j} corresponds to a coefficient at row i and column j in an eigenvector matrix, such that v_{i,j}=α_{i,j}e^{j2πφ}^{_{i,j}}. The UE 102 may include a set of strongest coefficients, or all of the coefficients, in the feedback information transmitted 414a-414b to the network entity 104 with the quantized amplitude α_{i,j} and phase φ_{i,j}.

The network entity 104 may calculate the cosine similarity or the square cosine similarity for the uncompressed CSI and the decompressed ML-based CSI reported in the feedback information 414a-414b received from the UE 102. If the cosine similarity or the square cosine similarity is below the threshold (or otherwise fulfills a fourth threshold criterion), the network entity 104 might determine that an ML model performance failure instance has occurred. That is, the network entity 104 interprets the feedback information received 414a-414b from the UE 102 for ML model performance failure monitoring 416a-416b and/or detection 416b.

In examples, after determining that N consecutive ML model performance failure instances have occurred, the network entity 104 might determine that an ML model performance failure event is detected 416b. Like the multiple instances of downlink signal transmissions 310a-310b and the multiple occasions of ML model performance monitoring 316a-316b that may occur in the signaling diagram 300 before an ML model performance failure event is detected 316b at the UE 102, the signaling diagram 400 can similarly include the multiple instances of the downlink signal transmissions 310a-310b, multiple occasions of determining 412a-412b and transmitting 414a-414b feedback information to the network entity 104, and multiple occasions of ML model performance monitoring 416a-416b before an ML model performance failure event is detected 416b at the network entity 104. Upon detection 416b of the ML model performance failure event, the network entity may transmit 420 control signaling to the UE 102 to fallback to non-ML based CSI reporting techniques or to update/switch the ML model. The control signaling transmitted 420 to the UE 102 in the signaling diagram 400 may correspond to same or similar control signaling as transmitted 320 to the UE in the signaling diagram 300. The control signaling may correspond to RRC signaling, a MAC-CE, or DCI. The UE 102 and the network entity 104 may proceed to communicate 322 based on the non-ML based CSI reporting techniques or the updated/switched ML model.

The network entity 104 may configure the UE 102 to include BLER information (e.g., hypothetical BLER) in the feedback information transmitted 414a-414b to the network entity 104 based on one or more measurements of the downlink signals. In examples, the downlink signals might correspond to CSI-RS, based on CSI-RS resources configured by the network entity 104 through the RRC signaling, MAC-CE, or DCI. In other examples, the downlink signals correspond to PDSCH transmissions or DCI that schedules the PDSCH transmissions. Thus, then network entity 104 can indicate whether the hypothetical BLER is to be reported via the PDSCH. The UE 102 may measure the hypothetical BLER based on at least one of a target spectrum efficiency per layer or a target spectrum efficiency per number of layers. The UE 102 can determine the target spectrum efficiency per layer from a most recently reported CQI and a number of layers from the most recently reported RI for the ML-based CSI report. The network entity 104 may configure the target spectrum efficiency per layer and the target spectrum efficiency per number of layers through the RRC signaling, MAC-CE, or DCI.

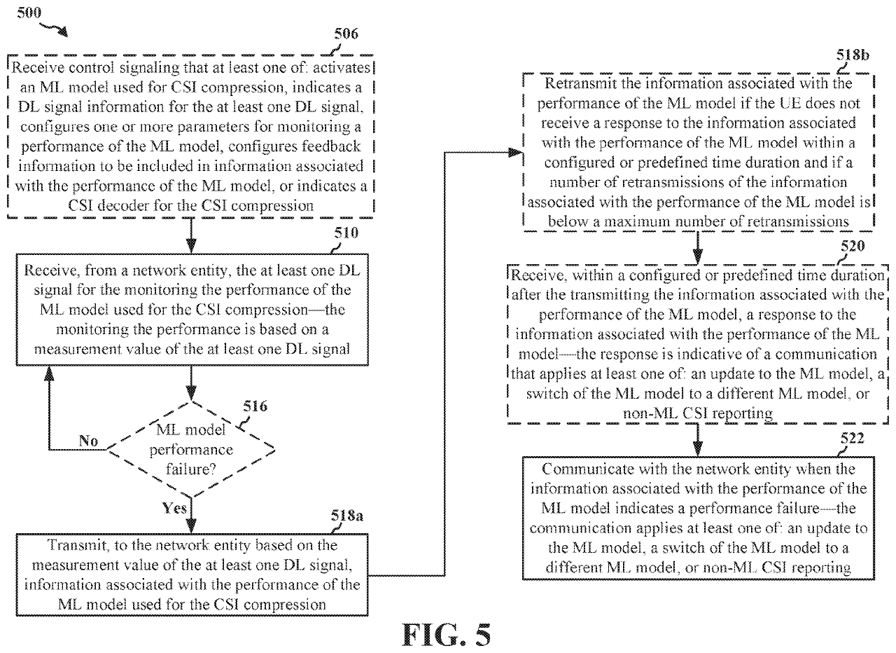

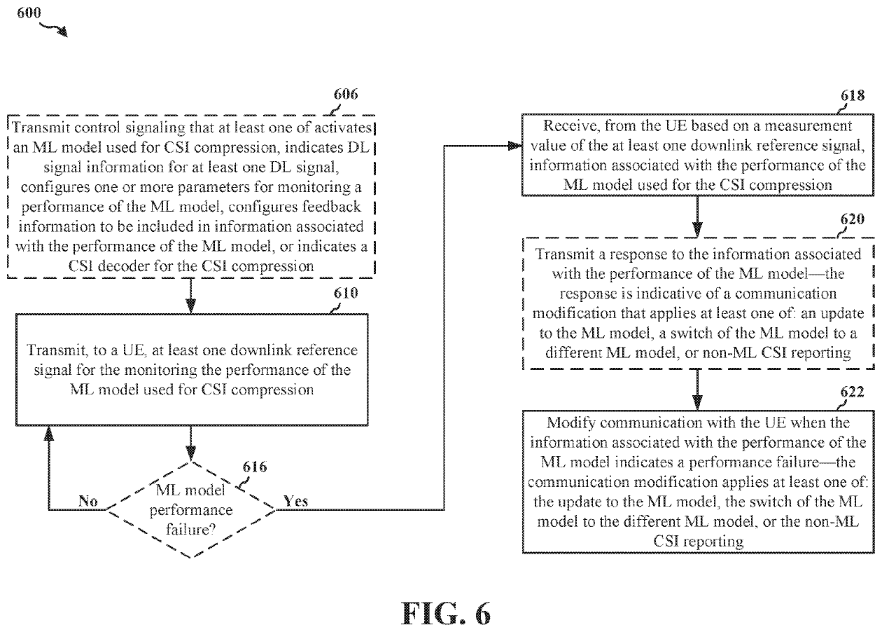

The UE 102 may transmit 414a-414b the hypothetical BLER to the network entity 104 on PUCCH/PUSCH resources. The network entity may configure or indicate the PUCCH/PUSCH resources via RRC signaling, MAC-CE, or DCI. A number of reported bits for the hypothetical BLER may be based on a predefined protocol or configured by the network entity 104 via the RRC signaling. The UE 102 can either explicitly report the hypothetical BLER or indicated whether the hypothetical BLER exceeds the threshold, where the threshold may be predefined (e.g. target BLER for a CQI report for ML-based CSI reporting) or configured by the network entity via RRC signaling. The RRC signaling may indicate am RRC reconfiguration message from the network entity 104 to the UE 102, a system information block (SIB), where the SIB can be a predefined SIB (e.g., SIB1) or a different SIB transmitted by the network entity 104. The network entity 104 may also determine a UE capability via UE capability report signaling or from another network entity or a core network (e.g., AMF). FIGS. 3-4 illustrate ML model performance failure monitoring. FIGS. 5-6 show methods for implementing one or more aspects of FIGS. 3-4. In particular, FIG. 5 shows an implementation by the UE 102 of the one or more aspects of FIGS. 3-4. FIG. 6 shows an implementation by the network entity 104 of the one or more aspects of FIGS. 3-4.

FIG. 5 illustrates a flowchart 500 of a method performed by a UE 102 for performance failure monitoring of an ML. With reference to FIGS. 1-4, the method may be performed by the UE 102, the UE apparatus 702, etc., which may include the memory 724′ and which may correspond to the entire UE 102 or the UE apparatus 702, or a component of the UE 102 or the UE apparatus 702, such as the wireless baseband processor 724.

The UE 102 receives 506 control signaling that at least one of: activates an ML model used for CSI compression, indicates downlink (DL) signal information for the at least one DL signal, configures one or more parameters for monitoring a performance of the ML model, configures feedback information to be included in information associated with the performance of the ML model, or indicates a CSI decoder for the CSI compression. For example, referring to FIG. 3, the UE 102 receives 306 control signaling from the network entity 104 to enable ML-based CSI compression and to configure downlink signals/parameters for ML model monitoring. Referring to FIG. 4 as another example, the UE 102 receives 406 control signaling from the network entity 104 that also configures UE feedback for ML model monitoring.

The UE 102 receives 510, from a network entity, the at least one DL signal for the monitoring the performance of the ML model used for the CSI compression—the monitoring the performance is based on a measurement value of the at least one DL signal. For example, referring to FIGS. 3-4, the UE 102 receives 310a-310b downlink signals from the network entity 104 for ML model monitoring.

The UE 102 determines 516 whether an ML model performance failure has occurred. For example, referring to FIG. 3, the UE 102 monitors 316a-316b for ML model performance failure. If the UE 102 determines 516 that the ML model performance failure has not occurred (or if the UE does not perform the ML model performance failure monitoring, which is shown in FIG. 4), the UE 102 returns to the receiving 510 the at least one downlink signal for the monitoring the performance of the ML model.

If the UE 102 determines 516 that the ML model performance failure has occurred, the UE 102 transmits 518a, to the network entity based on the measurement value of the at least one DL signal, information associated with the performance of the ML model used for the CSI compression. For example, referring to FIG. 3, the UE 102 transmits 318 an ML model performance failure event report to the network entity 104 based on detection 316b of the ML model performance failure. Referring to FIG. 4 as another example, the UE 102 transmits 414a-414b feedback information (e.g., BLER, uncompressed CSI, etc.) to the network entity 104 for the ML model monitoring based on the UE 102 determining 412a-412b the feedback information for the ML model monitoring.

The UE 102 retransmits 518b the information associated with the performance of the ML model if the UE does not receive a response to the information associated with the performance of the ML model within a configured or predefined time duration and if a number of retransmissions of the information associated with the performance of the ML model is below a maximum number of retransmissions. For example, referring to FIG. 3, the transmission 318 can be a retransmission of the ML model performance failure event report. Referring to FIG. 4 as another example, the transmissions 414a-414b can be retransmissions of the feedback information for the ML model monitoring.

The UE 102 receives 520, within a configured or predefined time duration after the transmitting the information associated with the performance of the ML model, a response to the information associated with the performance of the ML model—the response is indicative of a communication that applies at least one of: an update to the ML model, a switch of the ML model to a different ML model, or non-ML CSI reporting. For example, referring to FIG. 3, the UE 102 receives 320 a response to the ML model performance failure event report. Referring to FIG. 4, the UE 102 receives 420 a fallback indication to non-ML based CSI reporting or to an updated/switched ML model.

The UE 102 communicates 522 with the network entity when the information associated with the performance of the ML model indicates a performance failure—the communication applies at least one of: an update to the ML model, a switch of the ML model to a different ML model, or non-ML CSI reporting. For example, referring to FIGS. 3-4, the UE 102 communicates 322 with the network entity 104 based on the non-ML based CSI reporting or the updated/switched ML model. FIG. 5 describes a method from a UE-side of a wireless communication link, whereas FIG. 6 describes a method from a network-side of the wireless communication link.

FIG. 6 is a flowchart 600 of a method performed by a network entity 104 for performance failure monitoring of an ML. With reference to FIGS. 1-4, the method may be performed by a base station or one or more network entities 104 at the base station, which may correspond to the RU 106, the DU 108, the CU 110, an RU processor 842, a DU processor 832, a CU processor 812, etc. The base station or the one or more network entities 104 at the base station may include the memory 812′/832′/842′, which may correspond to an entirety of the one or more network entities 104 or the base station, or a component of the one or more network entities 104 or the base station, such as the RU processor 842, the DU processor 832, or the CU processor 812.

The base station or the one or more network entities 104 of the base station transmits 606 control signaling that at least one of: activates an ML model used for CSI compression, indicates DL signal information for at least one DL signal, configures one or more parameters for monitoring a performance of the ML model, configures feedback information to be included in information associated with the performance of the ML model, or indicates a CSI decoder for the CSI compression. For example, referring to FIG. 3, the network entity 104 transmits 306 control signaling to the UE 102 to enable ML-based CSI compression and to configure downlink signals/parameters for ML model monitoring. Referring to FIG. 4 as another example, the network entity 104 transmits 406 control signaling to the UE 102 that also configures UE feedback for ML model monitoring.

The base station or the one or more network entities 104 of the base station transmits 610, to a UE, at least one downlink signal for the monitoring the performance of the ML model used for CSI compression. For example, referring to FIGS. 3-4, the network entity 104 transmits 310a-310b downlink signals to the UE 102 for ML model monitoring.

The base station or the one or more network entities 104 of the base station determines 616 whether an ML model performance failure has occurred. For example, referring to FIG. 4, the network entity 104 monitors 416a-416b for ML model performance failure. If the base station or the one or more network entities 104 of the base station determines 516 that the ML model performance failure has not occurred, the base station or the one or more network entities 104 of the base station returns to the transmitting 610 the at least one downlink signal for the monitoring the performance of the ML model.

If the base station or the one or more network entities 104 of the base station determines 616 that the ML model performance failure has occurred (or if the base station does not perform the ML model performance failure monitoring, which is shown in FIG. 3), the base station or the one or more network entities 104 of the base station receives 618, from the UE based on a measurement value of the at least one downlink signal, information associated with the performance of the ML model used for the CSI compression. For example, referring to FIG. 3, the network entity 104 receives 318 an ML model performance failure event report from the UE 102 based on detection 316b of the ML model performance failure. Referring to FIG. 4 as another example, the network entity 104 receives 414a-414b feedback information (e.g., BLER, uncompressed CSI, etc.) from the UE 102 for the ML model monitoring for the network entity 104 to determine 416a-416b and/or detect 416b an ML model performance failure.

The base station or the one or more network entities 104 of the base station transmits 620 a response to the information associated with the performance of the ML model—the response is indicative of a communication modification that applies at least one of: an update to the ML model, a switch of the ML model to a different ML model, or non-ML CSI reporting. For example, referring to FIG. 3, the network entity 104 transmits 320 a response to the ML model performance failure event report. Referring to FIG. 4 as another example, the network entity 104 transmits 420 a fallback indication to non-ML based CSI reporting or to an updated/switched ML model.

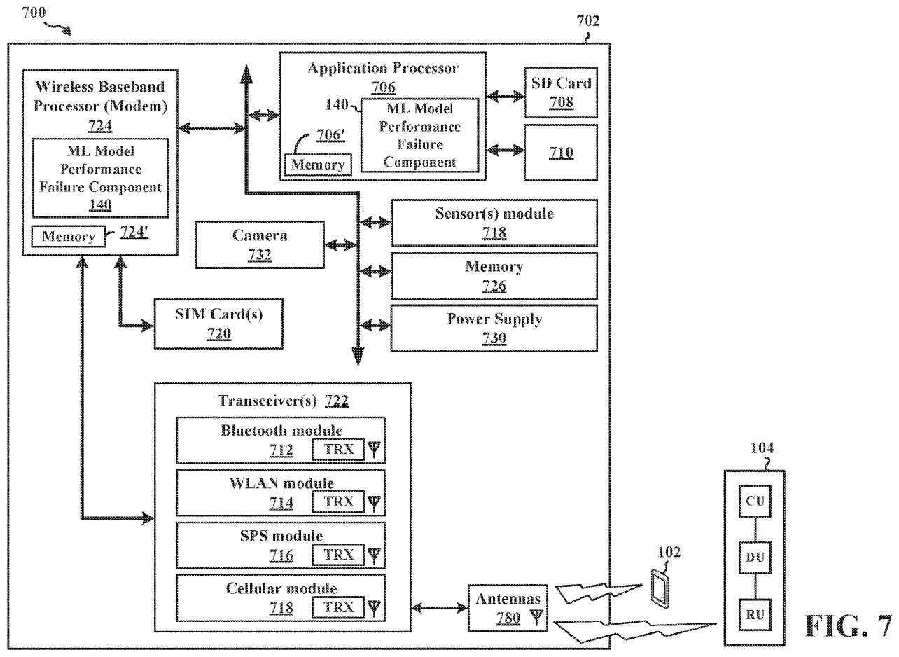

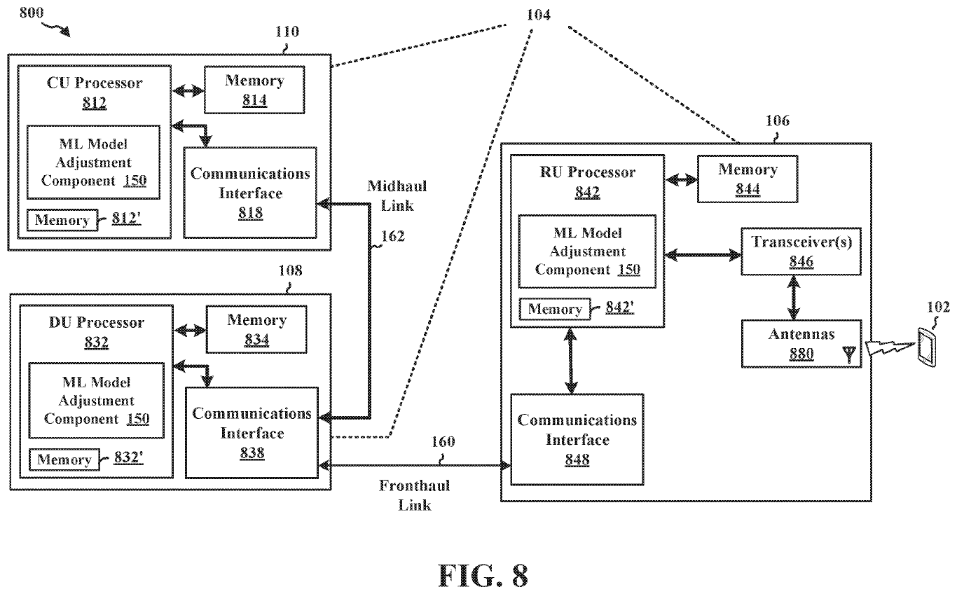

The base station or the one or more network entities 104 of the base station modifies 622 communications with the UE when the information associated with the performance of the ML model indicates a performance failure—the communication modification applies at least one of: the update to the ML model, the switch of the ML model to the different ML model, or the non-ML CSI reporting. For example, referring to FIGS. 3-4, the network entity communication 322 with the UE 102 is modified based on the non-ML based CSI reporting or the updated/switched ML model. A UE apparatus 702, as described in FIG. 7, may perform the method of flowchart 500. The base station or the one or more network entities 104 of the base station, as described in FIG. 8, may perform the method of flowchart 600.

FIG. 7 is a diagram 700 illustrating an example of a hardware implementation for a UE apparatus 702. The apparatus 702 may be the UE 102, a component of the UE, or may implement UE functionality. In some aspects, the apparatus 702 may include a wireless baseband processor 724 (also referred to as a modem) coupled to one or more transceivers 722 (e.g., wireless RF transceiver). The wireless baseband processor 724 may include on-chip memory 724′. In some aspects, the apparatus 702 may further include one or more subscriber identity modules (SIM) cards 720 and an application processor 706 coupled to a secure digital (SD) card 708 and a screen 710. The application processor 706 may include on-chip memory 706′.

The apparatus 702 may further include a Bluetooth module 712, a WLAN module 714, an SPS module 716 (e.g., GNSS module), and a cellular module 717 within the one or more transceivers 722. The Bluetooth module 712, the WLAN module 714, the SPS module 716, and the cellular module 717 may include an on-chip transceiver (TRX) (or in some cases, just a receiver (RX)). The Bluetooth module 712, the WLAN module 714, the SPS module 716, and the cellular module 717 may include their own dedicated antennas and/or utilize the antennas 780 for communication. The apparatus 702 may further include one or more sensor modules 718 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 726, a power supply 730, and/or a camera 732.

The wireless baseband processor 724 communicates through the transceiver(s) 722 via one or more antennas 780 with another UE 102 and/or with an RU associated with a network entity 104. The wireless baseband processor 724 and the application processor 706 may each include a computer-readable medium/memory 724′, 706′, respectively. The additional modules of memory 726 may also be considered a computer-readable medium/memory. Each computer-readable medium/memory 724′, 706′, 726 may be non-transitory. The wireless baseband processor 724 and the application processor 706 are each responsible for general processing, including the execution of software stored on the computer-readable medium/memory. The software, when executed by the wireless baseband processor 724/application processor 706, causes the wireless baseband processor 724/application processor 706 to perform the various functions described. The computer-readable medium/memory may also be used for storing data that is manipulated by the wireless baseband processor 724/application processor 706 when executing software. The wireless baseband processor 724/application processor 706 may be a component of the UE 102. The apparatus 702 may be a processor chip (modem and/or application) and include just the wireless baseband processor 724 and/or the application processor 706, and in another configuration, the apparatus 702 may be the entire UE 102 and include the additional modules of the apparatus 702.

As discussed, the ML model performance failure component 140 is configured to receive, from a network entity, at least one downlink signal for monitoring a performance of a ML model used for channel state information (CSI) compression, wherein the monitoring the performance is based on a measurement value of the at least one downlink signal; transmit, to the network entity based on the measurement value of the at least one downlink signal, information associated with the performance of the ML model used for the CSI compression; and communicate with the network entity when the information associated with the performance of the ML model indicates a performance failure, wherein the communication applies at least one of: an update to the ML model, a switch of the ML model to a different ML model, or non-ML CSI reporting. The ML model performance failure component 140 may be within the wireless baseband processor 724, the application processor 706, or both the wireless baseband processor 724 and the application processor 706. The ML model performance failure component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 702 may include a variety of components configured for various functions. In one configuration, the apparatus 702, and in particular the wireless baseband processor 724 and/or the application processor 706, includes means for receiving, from a network entity, at least one downlink signal for monitoring a performance of an ML model used for CSI compression, wherein the monitoring the performance is based on a measurement value of the at least one downlink signal; means for transmitting, to the network entity based on the measurement value of the at least one downlink signal, information associated with the performance of the ML model used for the CSI compression; and means for communicating with the network entity when the information associated with the performance of the ML model indicates a performance failure, wherein the communication applies at least one of: an update to the ML model, a switch of the ML model to a different ML model, or non-ML CSI reporting. The apparatus 702 further includes means for receiving control signaling that at least one of: activates the ML model used for the CSI compression, indicates downlink signal information for the at least one downlink signal, configures one or more parameters for the monitoring the performance of the ML model, configures feedback information to be included in the information associated with the performance of the ML model, or indicates a CSI decoder for the CSI compression. The means for communicating with the network entity further is further configured to: transmit the performance failure report to the network entity over at least one of a MAC-CE, a PUCCH, or a PRACH. The apparatus 702 further includes means for transmitting a dedicated SR for uplink resources for the transmitting the performance failure report to the network entity; means for receiving a configuration of the uplink resources for the transmitting the performance failure report to the network entity; and means for transmitting the performance failure report to the network entity over the MAC-CE on the uplink resources. The apparatus 702 further includes means for receiving, within a configured or predefined time duration after the transmitting the information associated with the performance of the ML model, a response to the information associated with the performance of the ML model, wherein the response is indicative of the communication that applies the at least one of: the update to the ML model, the switch of the ML model to the different ML model, or the non-ML CSI reporting. The apparatus 702 further includes means for retransmitting the information associated with the performance of the ML model if the UE does not receive a response to the information associated with the performance of the ML model within a configured or predefined time duration and if a number of retransmissions of the information associated with the performance of the ML model is below a maximum number of retransmissions. The means may be the ML model performance failure component 140 of the apparatus 702 configured to perform the functions recited by the means.

FIG. 8 is a diagram 800 illustrating an example of a hardware implementation for one or more network entities 104. The one or more network entities 104 may be a BS, a component of a BS, or may implement BS functionality. The one or more network entities 104 may include at least one of a CU 810, a DU 830, or an RU 840. For example, the component 199 may sit at the one or more network entities 104, such as the CU 810; both the CU 810 and the DU 830; each of the CU 810, the DU 830, and the RU 840; the DU 830; both the DU 830 and the RU 840; or the RU 840.

The CU 810 may include a CU processor 812. The CU processor 812 may include on-chip memory 812′. In some aspects, the CU 810 may further include additional memory modules 814 and a communications interface 818. The CU 810 communicates with the DU 830 through a midhaul link 162, such as an F1 interface. The DU 830 may include a DU processor 832. The DU processor 832 may include on-chip memory 832′. In some aspects, the DU 830 may further include additional memory modules 834 and a communications interface 838. The DU 830 communicates with the RU 840 through a fronthaul link 160. The RU 840 may include an RU processor 842. The RU processor 842 may include on-chip memory 842′. In some aspects, the RU 840 may further include additional memory modules 844, one or more transceivers 846, antennas 880, and a communications interface 848. The RU 840 communicates wirelessly with the UE 102.

The on-chip memory 812′, 832′, 842′ and the additional memory modules 814, 834, 844 may each be considered a computer-readable medium/memory. Each computer-readable medium/memory may be non-transitory. Each of the processors 812, 832, 842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed, the ML model adjustment component 150 is configured to transmit, to a UE, at least one downlink signal for monitoring a performance of a ML model used for CSI compression; receive, from the UE based on a measurement value of the at least one downlink signal, information associated with the performance of the ML model used for the CSI compression; and modify communication with the UE when the information associated with the performance of the ML model indicates a performance failure, wherein the communication modification applies at least one of: an update to the ML model, a switch of the ML model to a different ML model, or non-ML CSI reporting. The ML model adjustment component 150 may be within one or more processors of one or more of the CU 810, DU 830, and the RU 840. The ML model adjustment component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The one or more network entities 104 may include a variety of components configured for various functions. In one configuration, the one or more network entities 104 includes means for transmitting, to a UE, at least one downlink signal for monitoring a performance of a ML model used for CSI compression; receiving, from the UE based on a measurement value of the at least one downlink signal, information associated with the performance of the ML model used for the CSI compression; and modifying communication with the UE when the information associated with the performance of the ML model indicates a performance failure, where the communication modification applies at least one of: an update to the ML model, a switch of the ML model to a different ML model, or non-ML CSI reporting. The one or more network entities 104 further include means for transmitting control signaling that at least one of activates the ML model used for the CSI compression, indicates downlink signal information for the at least one downlink signal, configures one or more parameters for the monitoring the performance of the ML model, configures feedback information to be included in the information associated with the performance of the ML model, or indicates a CSI decoder for the CSI compression. The means for modifying the communication with the UE further is further configured to: receive the performance failure report from the UE over at least one of a MAC-CE, a PUCCH, or a PRACH. The one or more network entities 104 further include means for receiving a dedicated scheduling request for uplink resources for the receiving the performance failure report from the UE; means for transmitting a configuration of the uplink resources for the receiving the performance failure report from the UE; and means for receiving the performance failure report from the UE over the MAC-CE on the uplink resources. The one or more network entities 104 further include means for transmitting a response to the information associated with the performance of the ML model, where the response is indicative of the communication modification that applies the at least one of: the update to the ML model, the switch of the ML model to the different ML model, or the non-ML CSI reporting. The means may be the ML model adjustment component 150 of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, at least one downlink signal for monitoring a performance of an ML model used for CSI compression, and includes that the monitoring the performance is based on a measurement value of the at least one downlink signal; transmitting, to the network entity based on the measurement value of the at least one downlink signal, information associated with the performance of the ML model used for the CSI compression; and communicating with the network entity when the information associated with the performance of the ML model indicates a performance failure, and includes that the communication applies at least one of: an update to the ML model, a switch of the ML model to a different ML model, or non-ML CSI reporting.

Example 2 may be combined with example 1 and further includes receiving control signaling that at least one of: activates the ML model used for the CSI compression, indicates downlink signal information for the at least one downlink signal, configures one or more parameters for the monitoring the performance of the ML model, configures feedback information to be included in the information associated with the performance of the ML model, or indicates a CSI decoder for the CSI compression.

Example 3 may be combined with any of examples 1-2 and includes that the information associated with the performance of the ML model corresponds to at least one of: the feedback information or a performance failure report associated with detection of the performance failure, the feedback information indicative of whether the performance of the ML model contributed to the performance failure.

Example 4 may be combined with example 3 and includes that the communicating with the network entity further includes: transmitting the performance failure report to the network entity over at least one of a MAC-CE, a PUCCH, or a PRACH.

Example 5 may be combined with any of examples 3-4 and further includes transmitting a dedicated scheduling request for uplink resources for the transmitting the performance failure report to the network entity; receiving a configuration of the uplink resources for the transmitting the performance failure report to the network entity; and transmitting the performance failure report to the network entity on the uplink resources.

Example 6 may be combined with any of examples 1-5 and further includes receiving, within a configured or predefined time duration after the transmitting the information associated with the performance of the ML model, a response to the information associated with the performance of the ML model, and includes that the response is indicative of the communication that applies the at least one of: the update to the ML model, the switch of the ML model to the different ML model, or the non-ML CSI reporting.

Example 7 may be combined with any of examples 1-5 and further includes retransmitting the information associated with the performance of the ML model if the UE does not receive a response to the information associated with the performance of the ML model within a configured or predefined time duration and if a number of retransmissions of the information associated with the performance of the ML model is below a maximum number of retransmissions.

Example 8 may be combined with any of examples 1-7 and includes that the at least one downlink signal for the monitoring the performance of the ML model corresponds to at least one of a DMRS, a PDSCH transmission, or a CSI-RS transmitted from a same number of antenna ports as a maximum number of downlink layers configured based on RRC signaling.

Example 9 may be combined with any of examples 1-8 and includes that at least one of a cosine similarity or a square cosine similarity for the monitoring the performance of the ML model applies at least one of a normalized eigenvector, an estimated channel for the at least one downlink signal, or a normalized channel for the at least one downlink signal, and includes that the performance failure of the ML model is based on the at least one of the cosine similarity or the square cosine similarity fulling a threshold criterion.

Example 10 may be combined with any of examples 1-9 and includes that the performance failure of the ML model is based on a number of consecutive failure detection instances associated with the measurement value of the at least one downlink signal.

Example 11 may be combined with any of examples 1-10 and includes that decompression of the CSI is based on the at least one downlink signal and at least one of: a subband size for decompressed CSI, a first number of bits for amplitude quantization, a second number of bits for phase quantization, or a third number of coefficients associated with the at least one downlink signal.

Example 12 may be combined with any of examples 1-11 and includes that the monitoring the performance of the ML model is based on a BLER associated with the measurement value of the at least one downlink signal, and includes that the performance failure of the ML model corresponds to the BLER fulfilling a BLER threshold criterion.

Example 13 may be combined with example 12 and includes that the BLER is based on at least one of: a first target average spectrum efficiency per layer or a second target average spectrum efficiency per number of layers.

Example 14 may be combined with any of examples 12-13 and includes that the information associated with the performance of the ML model includes the BLER.

Example 15 is a method of wireless communication at a network entity, including: transmitting, to a UE, at least one downlink signal for monitoring a performance of an ML model used for CSI compression; receiving, from the UE based on a measurement value of the at least one downlink signal, information associated with the performance of the ML model used for the CSI compression; and modifying communication with the UE when the information associated with the performance of the ML model indicates a performance failure, and includes that the communication modification applies at least one of: an update to the ML model, a switch of the ML model to a different ML model, or non-ML CSI reporting.

Example 16 may be combined with example 15 and further includes transmitting control signaling that at least one of activates the ML model used for the CSI compression, indicates downlink signal information for the at least one downlink signal, configures one or more parameters for the monitoring the performance of the ML model, configures feedback information to be included in the information associated with the performance of the ML model, or indicates a CSI decoder for the CSI compression.

Example 17 may be combined with any of examples 15-16 and includes that the information associated with the performance of the ML model corresponds to at least one of the feedback information or a performance failure report associated with detection of the performance failure, the feedback information indicative of whether the performance of the ML model contributed to the performance failure.

Example 18 may be combined with example 17 and includes that the modifying the communication with the UE further includes: receiving the performance failure report from the UE over at least one of a MAC-CE, a PUCCH, or a PRACH.

Example 19 may be combined with any of examples 15-18 and further includes receiving a dedicated scheduling request for uplink resources for the receiving the performance failure report from the UE; transmitting a configuration of the uplink resources for the receiving the performance failure report from the UE; and receiving the performance failure report from the UE on the uplink resources.

Example 20 may be combined with any of examples 15-19 and further includes transmitting a response to the information associated with the performance of the ML model, and includes that the response is indicative of the communication modification that applies the at least one of: the update to the ML model, the switch of the ML model to the different ML model, or the non-ML CSI reporting.

Example 21 may be combined with any of examples 15-20 and includes that the at least one downlink signal for the monitoring the performance of the ML model corresponds to at least one of a DMRS, a PDSCH transmission, or a CSI-RS transmitted from a same number of antenna ports as a maximum number of downlink layers configured based on RRC signaling.

Example 22 may be combined with any of examples 15-21 and includes that at least one of a cosine similarity or a square cosine similarity for the monitoring the performance of the ML model applies at least one of a normalized eigenvector, an estimated channel for the at least one downlink signal, or a normalized channel for the at least one downlink signal, and includes that the performance failure of the ML model is based on the at least one of the cosine similarity or the square cosine similarity fulfilling a threshold criterion.

Example 23 may be combined with any of examples 15-22 and includes that the performance failure of the ML model is based on a number of consecutive failure detection instances associated with receiving the feedback information from the UE.

Example 24 may be combined with any of examples 15-23 and includes that decompression of the CSI is based on the at least one downlink signal and at least one of: a subband size for decompressed CSI, a first number of bits for amplitude quantization, a second number of bits for phase quantization, or a third number of coefficients associated with the at least one downlink signal.

Example 25 may be combined with any of examples 15-24 and includes that the monitoring the performance of the ML model is based on a BLER associated with the measurement value of the at least one downlink signal, and includes that the performance failure of the ML model corresponds to the BLER fulfilling a BLER threshold criterion.

Example 26 may be combined with example 25 and includes that the BLER is based on at least one of: a first target average spectrum efficiency per layer or a second target average spectrum efficiency per number of layers.

Example 27 may be combined with any of examples 25-26 and includes that the information associated with the performance of the ML model includes the BLER.

Example 28 is an apparatus for wireless communication for implementing a method as in any of examples 1-27.

Example 29 is an apparatus for wireless communication including means for implementing a method as in any of examples 1-27.

Example 30 is a non-transitory computer-readable medium storing computer executable code, the code when executed by at least one processor causes the at least one processor to implement a method as in any of examples 1-27.

1. A method of wireless communication at a user equipment (UE), comprising:
receiving, from a network entity, a downlink signal for monitoring a performance of a machine learning (ML) model for channel state information (CSI) compression, the monitoring the performance being based on a measurement value of the downlink signal;
transmitting, to the network entity based on the measurement value of the downlink signal, information associated with the performance of the ML model for the CSI compression; and
communicating with the network entity when the information associated with the performance of the ML model indicates a performance failure, a communication being applied to at least one of: an update to the ML model, a switch of the ML model to a different ML model, or non-ML CSI reporting.

2. The method of claim 1, further comprising:
receiving control signaling that indicates at least one of:
activation of the ML model for the CSI compression,
downlink signal information for the at least one downlink signal,
a parameter for the monitoring the performance of the ML model,
feedback information for the information associated with the performance of the ML model, or
a CSI decoder for the CSI compression.

3. The method of claim 2, wherein the information associated with the performance of the ML model corresponds to at least one of: the feedback information or a performance failure report associated with detection of the performance failure, wherein the feedback information is indicative of whether the performance of the ML model contributed to the performance failure.

4. The method of claim 3, wherein the communicating with the network entity further comprises:
transmitting the performance failure report to the network entity over at least one of a medium access control-control element (MAC-CE), a physical uplink control channel (PUCCH), or a physical random access channel (PRACH).

5. The method of claim 4, further comprising:
transmitting a dedicated scheduling request (SR) for uplink resources for the transmitting the performance failure report to the network entity;
receiving a configuration of the uplink resources for the transmitting the performance failure report to the network entity; and
transmitting the performance failure report to the network entity on the uplink resources.

6. The method of claim 1, further comprising:
receiving, within a configured or predefined time duration after the transmitting the information associated with the performance of the ML model, a response to the information associated with the performance of the ML model, wherein the response is indicative of the communication that applies the at least one of: the update to the ML model, the switch of the ML model to the different ML model, or the non-ML CSI reporting.

7. The method of claim 1, further comprising:
retransmitting the information associated with the performance of the ML model if the UE does not receive a response to the information associated with the performance of the ML model within a configured or predefined time duration and if a number of retransmissions of the information associated with the performance of the ML model is below a maximum number of retransmissions.

8. The method of claim 1, wherein the downlink signal for the monitoring the performance of the ML model corresponds to at least one of a demodulation reference signal (DMRS), a physical downlink shared channel (PDSCH) transmission, or a channel state information-reference signal (CSI-RS) transmitted from a same number of antenna ports as a maximum number of downlink layers configured based on radio resource control (RRC) signaling.

9. The method of claim 1, wherein at least one of a cosine similarity or a square cosine similarity for the monitoring the performance of the ML model applies at least one of a normalized eigenvector, an estimated channel for the downlink signal, or a normalized channel for the downlink signal, and wherein the performance failure of the ML model is based on the at least one of the cosine similarity or the square cosine similarity fulfilling a threshold criterion.

10. The method of claim 1, wherein the performance failure of the ML model is based on a number of consecutive failure detection instances associated with the measurement value of the downlink signal.

11. The method of claim 1, wherein decompression of the CSI is based on the downlink signal and at least one of: a subband size for decompressed CSI, a first number of bits for amplitude quantization, a second number of bits for phase quantization, or a third number of coefficients associated with the downlink signal.

12. The method of claim 1, wherein the monitoring the performance of the ML model is based on a block error rate (BLER) associated with the measurement value of the downlink signal, and wherein the performance failure of the ML model corresponds to the BLER fulfilling a BLER threshold criterion.

13. The method of claim 12, wherein the BLER is based on at least one of: a first target average spectrum efficiency per layer or a second target average spectrum efficiency per number of layers.

14. The method of claim 12, wherein the information associated with the performance of the ML model includes the BLER.

15. A method of wireless communication at a network entity, comprising:
transmitting, to a user equipment (UE), a downlink signal for monitoring a performance of a machine learning (ML) model for channel state information (CSI) compression;
receiving, from the UE based on a measurement value of the downlink signal, information associated with the performance of the ML model for the CSI compression; and
modifying communication with the UE when the information associated with the performance of the ML model indicates a performance failure, a communication modification being applied to at least one of: an update to the ML model, a switch of the ML model to a different ML model, or non-ML CSI reporting.

16. The method of claim 15, further comprising:
transmitting control signaling that indicates at least one of:
activation of the ML model used for the CSI compression,
downlink signal information for the at least one downlink signal,
a parameters for the monitoring the performance of the ML model,
feedback information for the information associated with the performance of the ML model, or
a CSI decoder for the CSI compression.

17. The method of claim 16, wherein the information associated with the performance of the ML model corresponds to at least one of: the feedback information or a performance failure report associated with detection of the performance failure, wherein the feedback information is indicative of whether the performance of the ML model contributed to the performance failure.

18. The method of claim 15, further comprising:
transmitting a response to the information associated with the performance of the ML model, wherein the response is indicative of the communication modification that applies the at least one of: the update to the ML model, the switch of the ML model to the different ML model, or the non-ML CSI reporting.

19. An apparatus for wireless communication at a user equipment (UE), comprising:
a transceiver;
a memory; and
a processor coupled to the memory and the transceiver, the processor configured to:
receive, from a network entity, a downlink signal for monitoring a performance of a machine learning (ML) model for channel state information (CSI) compression, the monitoring the performance being based on a measurement value of the downlink signal;
transmit, to the network entity based on the measurement value of the downlink signal, information associated with the performance of the ML model for the CSI compression; and
communicate with the network entity when the information associated with the performance of the ML model indicates a performance failure, a communication being applied to at least one of: an update to the ML model, a switch of the ML model to a different ML model, or non-ML CSI reporting.

20. The apparatus of claim 19, wherein the processor is further configured to:
receive control signaling that indicates at least one of:
activation of the ML model for the CSI compression,
downlink signal information for the at least one downlink signal,
a parameter for the monitoring the performance of the ML model,
feedback information for the information associated with the performance of the ML model, or
a CSI decoder for the CSI compression.
